(19) United States
(12) Patent Application Publication
(10) Pub. No.: US 2012/0043918 A1
(43) Pub. Date: Feb. 23, 2012

(54) REVERSING DISPENSER MOTOR WITH INTEGRAL RELAY

(76) Inventors: Arun Madhav TALEGAONKAR, Louisville, KY (US); Joseph Thomas Waugh, Louisville, KY (US); Eric Paez, Louisville, KY (US); Christopher David Hunter, Louisville, KY (US)

(21) Appl. No.: 12/857,916

(22) Filed: Aug. 17, 2010

(51) Int. Cl. H02P 1/22

(52) U.S. Cl. 318/294

(57) ABSTRACT

A dispensing motor apparatus includes a motor assembly for driving a dispenser, the motor assembly having a motor. The dispenser is driven by the motor. One or more relays having electrical contacts can be integrated with the motor assembly. The motor changes its direction of rotation when its polarity is switched by relay(s). Additionally, a controller can communicate with the relay(s) and the motor assembly, such that the controller permits the relay(s) to switch the position of the contacts of the relay(s) before power is turned on with respect to the motor through the electrical contacts and switch the position of the electrical contacts of the relay(s) to a default state after the power is removed from the motor through the electrical contacts. The relay(s) is subject to mechanical cycling without the contacts of relay(s) being required to perform a current switching duty.

### BACKGROUND OF THE INVENTION

The subject matter disclosed herein relates to dispensing devices. The subject matter disclosed herein further relates to refrigerators and, more particularly, to ice making assemblies and ice dispensers for refrigerators.

Some known refrigerators include an ice making assembly in a freezer storage compartment or in a door of a fresh food compartment of the refrigerator. The ice making assembly generally includes a mold body into which water is supplied. The water is then frozen to form ice pieces or cubes. The ice pieces are then moved to a storage bin where they are held until a user accesses ice from the refrigerator through an ice dispenser typically mounted through the door of the refrigerator.

FIG. 1 illustrates a schematic diagram of a prior art motor and relay configuration 11 utilized in conventional ice making assemblies and refrigerators. As indicated in FIG. 1, a relay component 33 includes a relay 31 containing electronic switches 27 and 29. The relay component 33 is located physically separate from the motor 17 and associated rectifier circuit 15. The motor 17 and the rectifier circuit 15 form a motor assembly 13. An auger motor input line 37 and an AC voltage line 39 connect electrically to the rectifier circuit 15. The motor 17 in turn connects to the switches 27 and 29 via respective lines 21 and 19. Lines 21 and 19 provide input to the motor 17. An electrified input 33 to the relay 31 relates to signals determinative of crushed or cubed ice.

The prior art configuration 11 is typically implemented in association with an ice bucket that dispenses crushed ice in one direction and cubed ice in another direction. Such an ice bucket (not shown in FIG. 1) is driven by the DC motor 17 that changes its direction when the polarity is switched. The switching is accomplished via the relay component 33. Since the electrical power flowing through the contacts of the switches 27 and 29 of the relay component 33 is DC (Direct Current), the relay 33 would need to be rated for DC power switching duty. Relays related to the switch DC power are physically larger and also more expensive, since switching a DC current imposes a greater erosion of the contacts and special means to extinguish the electrical that results from the switching action quickly. Thus, using an external relay 31 and external relay component 33 adds significantly to the wiring effort as well as the occupation of precious space and increases the probability of error during its manufacture.

### BRIEF DESCRIPTION OF THE INVENTION

As described herein, the preferred embodiments of the present invention overcome one or more of the above or other disadvantages known in the art.

One aspect of the present invention relates to a dispensing motor apparatus that includes a motor assembly for driving a dispenser, the motor assembly having a motor. The dispenser is driven by the motor. One or more relays having electrical contacts can be integrated with the motor assembly. The motor changes its direction of rotation when its polarity is switched by relay(s). Additionally, a controller communicates electrically with the relay(s) and the motor assembly, such that the controller permits the relay(s) to switch the position of the contacts of the relay(s) before power is turned on with respect to the motor through the electrical contacts and switch the position of the electrical contacts of the relay(s) to a default state after the power is removed from the motor through the electrical contacts. The relay(s) is subject to mechanical cycling only without the contacts of the relay(s) being required to perform an electrical current switching duty. Additionally, in some embodiments the relay(s) may be replaced by a solid state electronic switching device, such as, for example, a Triac or a transistor.

These and other aspects and advantages of the preferred embodiments of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a prior art reversing relay and motor configuration;

FIG. 2 illustrates a perspective view of a refrigerator in accordance with an exemplary embodiment of the current invention, in accordance with the disclosed embodiments;

FIG. 3 illustrates a perspective view of the refrigerator of FIG. 1 with the refrigerator doors being in an open position and the freezer door being removed for clarity, in accordance with the disclosed embodiments;

FIG. 4 illustrates an exploded view of the ice storage and dispense bin assembly, in accordance with the disclosed embodiments;

FIG. 5A illustrates a perspective view of the interior of the ice storage and dispense bin assembly, in accordance with the disclosed embodiments;

FIG. 5B illustrates a perspective view of the interior of the ice storage and dispense bin assembly, in accordance with the disclosed embodiments;

FIG. 6 illustrates a perspective view of the crusher which is integral to the ice storage and dispense bin assembly, in accordance with the disclosed embodiments;

FIG. 7 illustrates a block diagram of a control system, which can be utilized in accordance with the disclosed embodiments;

FIG. 8 illustrates a schematic diagram of a reversing relay integrated with a motor assembly housing, in accordance with the disclosed embodiments;

FIG. 9 illustrates a control logic chart, in accordance with the disclosed embodiments;

FIG. 10 illustrates logic timing diagrams with respect to a crushed mode and a cubed mode, in accordance with the disclosed embodiments;

FIG. 11 illustrates a block diagram of a motor in association with an overload protection component and a filter, in accordance with the disclosed embodiments; and

FIG. 12 illustrates a block diagram of a motor assembly having a solid-state electronic switching device for switching instead of a mechanical relay configuration, in accordance with the disclosed embodiments.

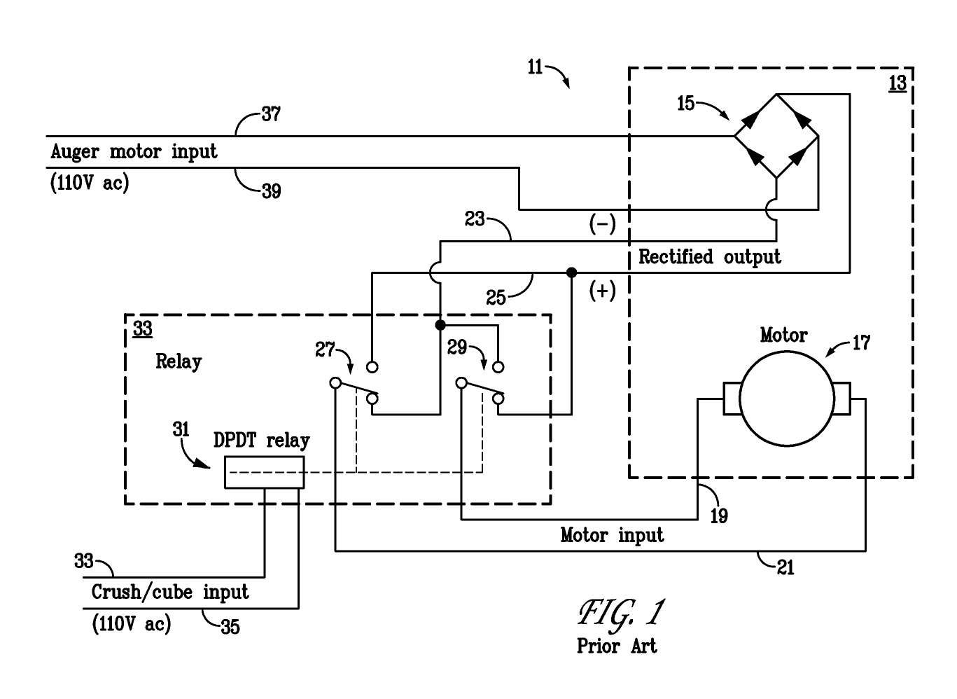

### DETAILED DESCRIPTION OF THE EXEMPLARY EMBODIMENTS OF THE INVENTION

The particular values and configurations discussed in these non-limiting examples can be varied and are cited merely to illustrate at least one of the disclosed embodiments and are not intended to limit the scope thereof.

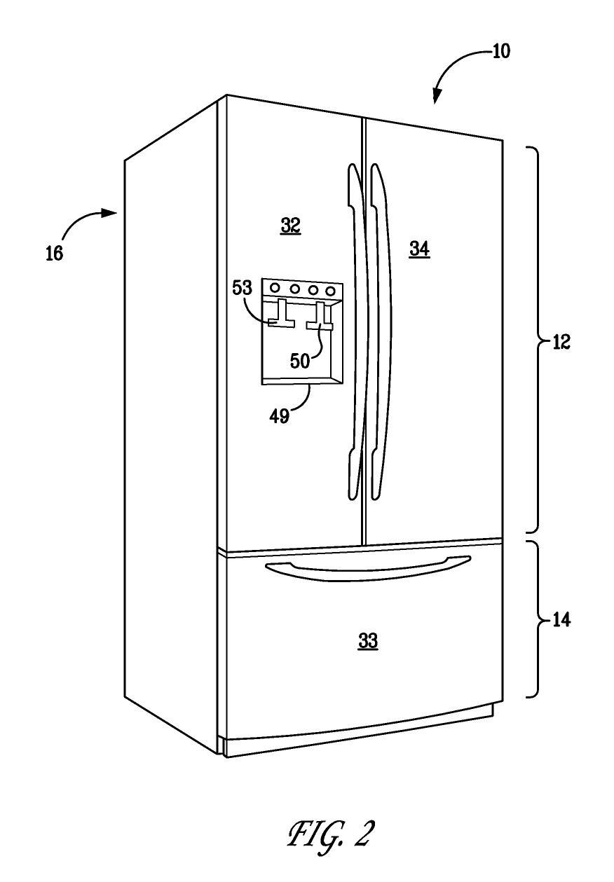

FIG. 2 illustrates an exemplary refrigerator 10 in which embodiments may be implemented. Note that while the embodiments described herein are discussed in the context of a specific refrigerator 10, it is contemplated that the embodiments may be practiced in other types of systems and devices. Therefore, as the benefits of the herein described embodiments accrue generally to dispensing devices and refrigerator, the description herein is for exemplary purposes only and is not intended to limit practice of the disclosed embodiments to a particular refrigeration appliance or machine, such as refrigerator 10.

As indicated in FIG. 2, an external access area 49 can be disposed in refrigerator 10 to receive drinking water and ice cubes. Upon a stimulus, a water dispenser 50 allows an outflow of drinking water into a user's receptacle. Upon another stimulus, an ice dispenser outlet 53 allows an outflow of whole ice cubes into a user's receptacle. Upon yet another stimulus, ice dispenser outlet 53 allows an outflow of crushed ice cubes into a user's receptacle. The refrigerator 10 can be configured with a fresh food compartment 12, a freezer compartment 14, two access doors 32 and 34 to the fresh food compartment 12, and one access door 33 to the freezer compartment 14. Refrigerator 10 is generally contained within an outer case 16.

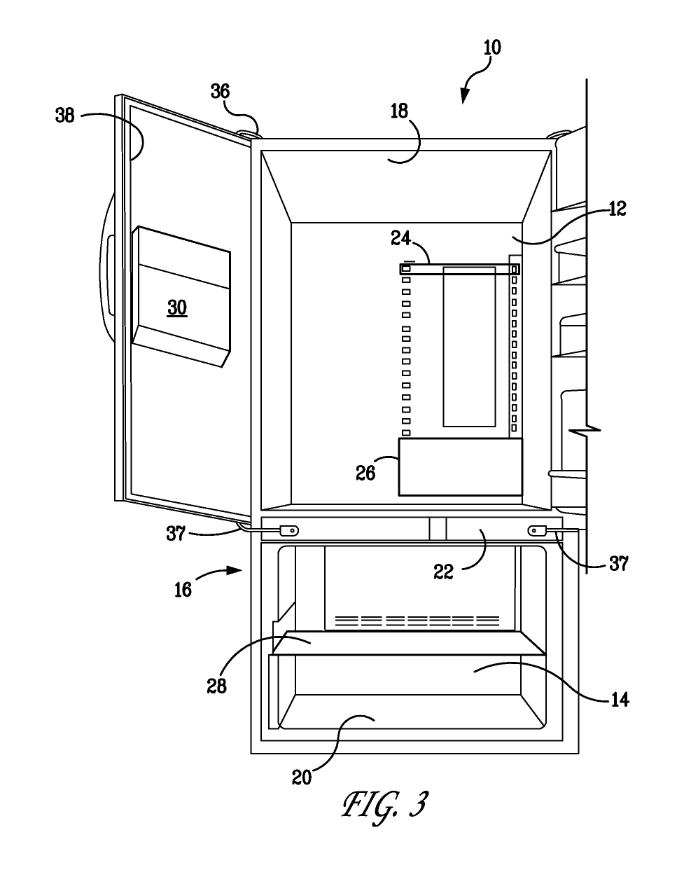

FIG. 3 illustrates the refrigerator 10 with its access doors 32, 34 in the open position. As shown, fresh food compartment 12 and freezer compartment 14 are arranged in a bottom mount refrigerator-freezer configuration. Refrigerator 10 includes outer case 16 and inner liners 18 and 20. A space between outer case 16 and liners 18 and 20, and between liners 18 and 20, is filled with foamed-in-place insulation. Outer case 16 normally is formed by folding a sheet of a suitable material, such as pre-painted steel, into an inverted U-shape to form top and sidewalls of the case. A bottom wall of outer case 16 normally is formed separately and attached to the case sidewalls and to a bottom frame that provides support for refrigerator 10. Inner liners 18 and 20 are molded from a suitable plastic material to form fresh food compartment 12 and freezer compartment 14, respectively. Alternatively, bending and welding a sheet of a suitable metal, such as steel, may form liners 18, 20. The illustrative embodiment includes two separate liners 18, 20 as it is a relatively large capacity unit and separate liners add strength and are easier to maintain within manufacturing tolerances.

The insulation in the space between liners 18, 20 can be covered by another strip of suitable resilient material, which also commonly is referred to as a mullion 22. Mullion 22 in one embodiment can be formed of an extruded ABS material.

Shelf 24 and slide-out drawer 26 can be provided in fresh food compartment 12 to support items being stored therein. A combination of shelves, such as shelf 28, is provided in freezer compartment 14.

In one embodiment, each of the access doors 32, 34 is mounted by a top hinge assembly 36 and a bottom hinge assembly 37 to rotate about its outer vertical edge between a closed position, as shown in FIG. 2, and an open position, as shown in FIG. 3. An ice storage and dispense bin assembly 30 can be seen on the interior of left side fresh food compartment door 32.

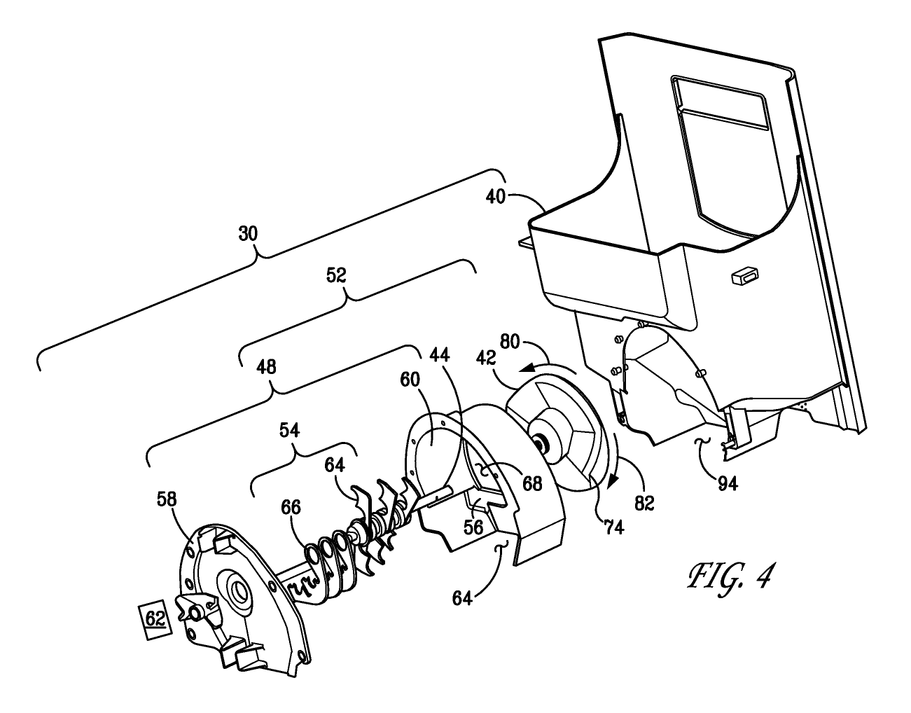

FIG. 4 illustrates an exploded view of the interior of exemplary ice making, storage and dispense bin assembly 30 within refrigerator 10, without any ice cubes in an ice storage bin 40, an agitator 42, an axle 44, a crusher assembly 48 and a motor 62. FIG. 4 further shows a view of the interior of crusher assembly 48, which includes a crusher 54, a front wall 56, a sidewall 60 and a back wall 58. FIG. 4 also depicts a view of the crusher 54, which includes a plurality of rotatable crusher arms 64 and a plurality of fixed blades 66.

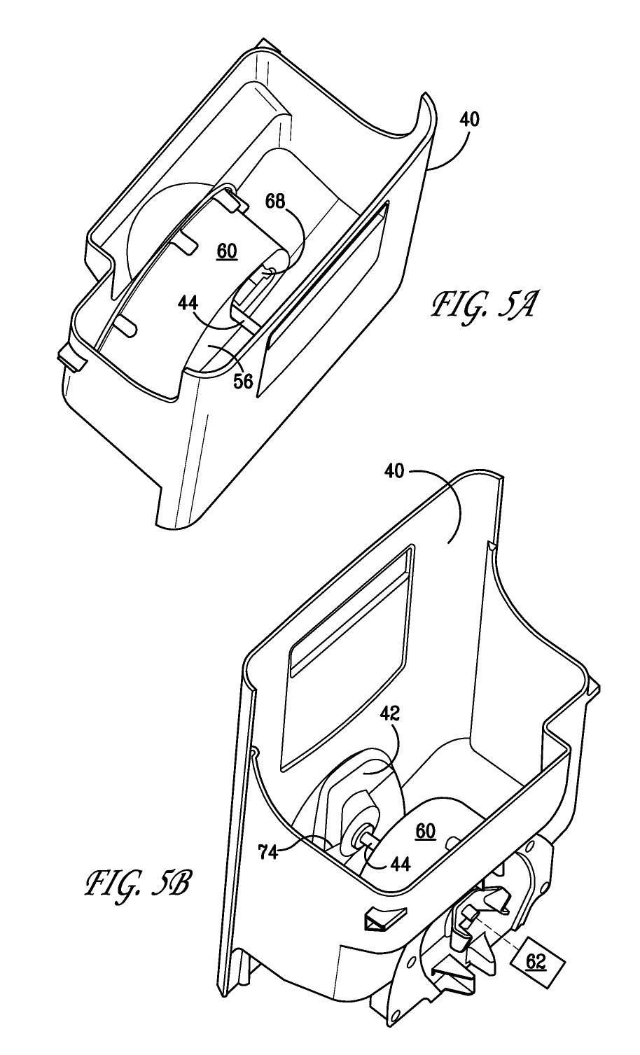

Ice storage and dispense bin assembly 30 can be within a separate ice production and storage compartment within fresh food compartment 12 or freezer compartment 14 of refrigerator 10. Ice storage and dispense bin assembly 30 includes the ice storage bin 40, which can be filled with whole ice cubes through the addition of whole ice cubes. Alternatively, the ice storage bin 40 can be filled with whole ice cubes from an automatic icemaker. Whole ice cubes within ice storage bin 40 settle in the bottom portion of ice storage bin 40. The bottom of ice storage bin 40 is angularly configured with a slope from the sidewalls of ice storage bin 40 towards a crusher assembly opening to direct whole ice cubes from ice storage bin 40 into crusher assembly 48 more efficiently. A crusher assembly opening 68 can be seen in FIG. 5A.

In FIG. 5B, a motor 62 and an agitator 42 are operatively affixed to axle 44. Axle 44 drives the rotation of agitator 42. Agitator 42 can rotate in either a counter-clockwise direction 80 or a clockwise direction 82 (FIG. 4). Agitator 42 facilitates the transport of whole ice cubes from ice storage bin 40 through crusher housing opening 68 (as seen in FIG. 5A) to crusher 54 (as seen in FIG. 4). Agitator 42 facilitates transport of whole ice cubes from ice storage bin 40 through crusher housing opening 68 to crusher 54 through rotation in either counter-clockwise direction 80 or clockwise direction 82. In one embodiment, agitator 42 has two raised portions 74 which extend at an angle from the face of agitator 42 and facilitate movement when they contact whole ice cubes. In other embodiments, agitator 42 can have one raised portion or a plurality of raised portions. Raised portions 74 facilitate movement of whole ice cubes from ice storage bin 40 through the crusher assembly opening to crusher 54 whether raised portions 74 are rotating in the counter-clockwise direction 80 or clockwise direction 82.

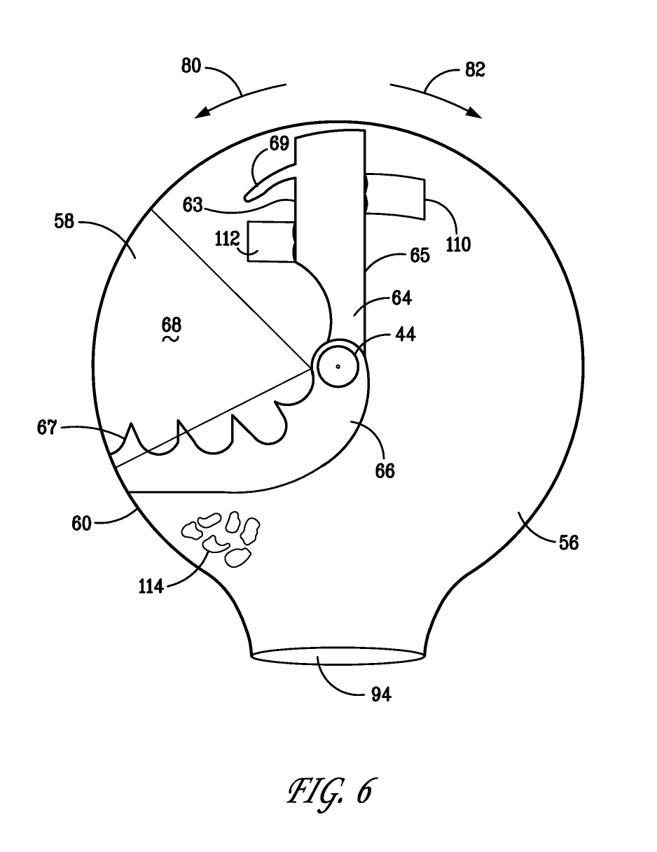

Referring back to FIG. 4, the interior of crusher assembly 48 can be seen. In one embodiment, motor 62 can be operatively affixed to back wall 58 and can also be operatively affixed to axle 44. In another embodiment motor 62 can be affixed to left side fresh food compartment door 32 and coupled to axle 44. In this second embodiment, motor 62 and axle 44 are generally coupled in a fork/coupling arrangement so that removal of ice storage bin 40 breaks the engagement of motor 62 and axle 44. Back wall 58 has an opening so that axle 44 can pass from motor 62, through back wall 58, through crusher 54, through an opening in front wall 56 to agitator 42. Sidewalls 60 of crusher assembly 48 seal back wall 58 to front wall 56 around the circumference of back wall 58 and front wall 56 while leaving a predetermined void 94 (FIG. 6). Predetermined void 94 allows the exit of whole ice cubes or crushed ice cubes from crusher assembly 48 through ice dispenser outlet 53 to a user's receptacle. In addition to the opening for axle 44 in front wall 56, crusher housing opening 68 is configured in front wall 56 to allow for communication and transport of whole ice cubes from ice storage bin 40 to the interior of crusher assembly 48. Crusher assembly opening 68 is preferably directly above the plurality of fixed blades 66.

Axle 44 also passes through crusher 54 by passing through the plurality of fixed blades 66 and the plurality of rotatable crusher arms 64. The plurality of fixed blades 66 remains stationary with respect to axle 44 and crusher assembly 48. The plurality of fixed blades 66 can be in a plane, which is perpendicular to axle 44, or the plurality of fixed blades 66 can be pitched at an angle. In one embodiment the plurality of fixed blades can be pitched at 60° from the plane which is perpendicular to axle 44. In one embodiment there can be three fixed blades 66, in other embodiments there can be one, two or more fixed blades 66.

The plurality of rotatable crusher arms 64 rotates in a counter-clockwise direction 80 or a clockwise direction 82. A detailed view of a single rotatable crusher arm 64 and a single fixed blade 66 is shown in FIG. 6. In this embodiment, front wall 56 is depicted as transparent.

Crusher housing opening 68 can be configured as an opening formed by the edge of front wall 56 and sidewall 60. Back wall 58 can be seen through crusher housing opening 68. Whole ice cubes from ice storage bin 40 (shown in FIG. 4) enter crusher-assembly 48 (shown in FIG. 4) through crusher housing opening 68. FIG. 6 shows a single rotatable crusher arm 64 and a single fixed blade 66 instead of a plurality of rotatable crusher arms 64 and a plurality of fixed blades 66 for ease of illustration and understanding. Single fixed blade 66 is affixed to sidewall 60 and supported by axle 44, and does not rotate. Single fixed blade 66 has a leading crusher edge 67.

Rotatable crusher arm 64 is rotatably affixed to axle 44 and rotates in counter-clockwise direction 80 or clockwise direction 82. If rotatable crusher arm 64 rotates in counter-clockwise direction 80, the leading counter-clockwise edge 63 causes a whole ice cube 112 to move until whole ice cube 112 is being contacted by a leading counter-clockwise edge 63 while the other side of whole ice cube 112 contacts leading crusher edge 67. As rotatable crusher arm 64 continues rotating in counter-clockwise direction 80 past fixed blade 66, whole ice cube 112 is crushed into crushed ice 114 and is dispensed through predetermined void 94 and ice dispenser outlet 53 to a user. Rotatable crusher arm 64 and axle 44 can rotate continuously around in either counter-clockwise direction 80 or clockwise direction 82. If more crushed ice cubes are desired, rotatable crusher arm 64 will continue to rotate in counter-clockwise direction 80 until enough crushed ice cubes have been delivered.

If rotatable crusher arm 64 rotates in clockwise direction 82, a leading clockwise edge 65 causes a whole ice cube 110 to move until whole ice cube 110 falls downward towards predetermined void 94, passes through predetermine void 94 and ice dispenser outlet 53 and is dispensed to a user. If more whole ice cubes are desired, rotatable crusher arm 64 will continue to rotate in clockwise direction 82, past fixed blade 66 until enough whole ice cubes have been delivered.

The design of the serrations of leading counter-clockwise edge 63 and leading crusher edge 67 can be any design which is suitable to move whole ice cubes from the area around crusher housing opening 68 on leading counter-clockwise edge 63 to leading crusher edge 67 and subsequently crush the whole ice cubes. A serration 69 is one example of a design, which is suitable to move whole ice cubes from the area around crusher housing opening 68.

The plurality of rotatable crusher arms 64 can be in a plane, which is perpendicular to axle 44, or the plurality of rotatable crusher arms 64 can be pitched at an angle. In one embodiment the plurality of rotatable crusher arms 64 can be pitched at 60° from the plane which is perpendicular to axle 44. If the plurality of rotatable crusher arms 64 are pitched at an angle, they act to draw whole ice cubes further into crusher assembly 48, from crusher housing opening 68 towards back wall 58 as they rotate. In one embodiment there can be three rotatable crusher arms 64, in other embodiments there can be one, two or more rotatable crusher arms 64. In some embodiments, the ice dispenser 52 can include the crusher assembly 48, the agitator 42, the axle 44 and the motor 62.

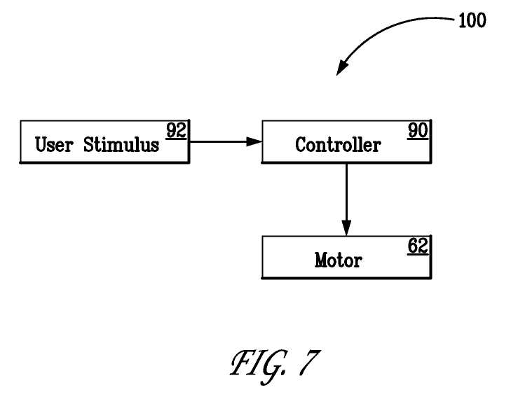

FIG. 7 illustrates a block diagram of an exemplary dispenser control system 100. Ice dispenser control system 100 generally includes motor 62, a controller 90 and a user stimulus 92. The control of motor 62 is based on user input 92, which input to the controller 90, for example, by programming particular control instructions into a memory of an application specific integrated circuit (ASIC) or other programmable memory device.

Controller 90 can be employed to control the operation of motor 62 based on user stimulus 92. If user stimulus 92 is a stimulus to receive whole ice cubes, motor 62 will rotate axle 44 causing the plurality of rotatable crusher arms 64 and agitator 42 to rotate in clockwise direction 82 (e.g., as seen in FIG. 4). If user stimulus 92 is a stimulus to receive crushed ice cubes, motor 62 will rotate axle 44 causing the plurality of rotatable crusher arms 64 and agitator 42 to rotate in counter-clockwise direction 80 (e.g., as seen in FIG. 4).

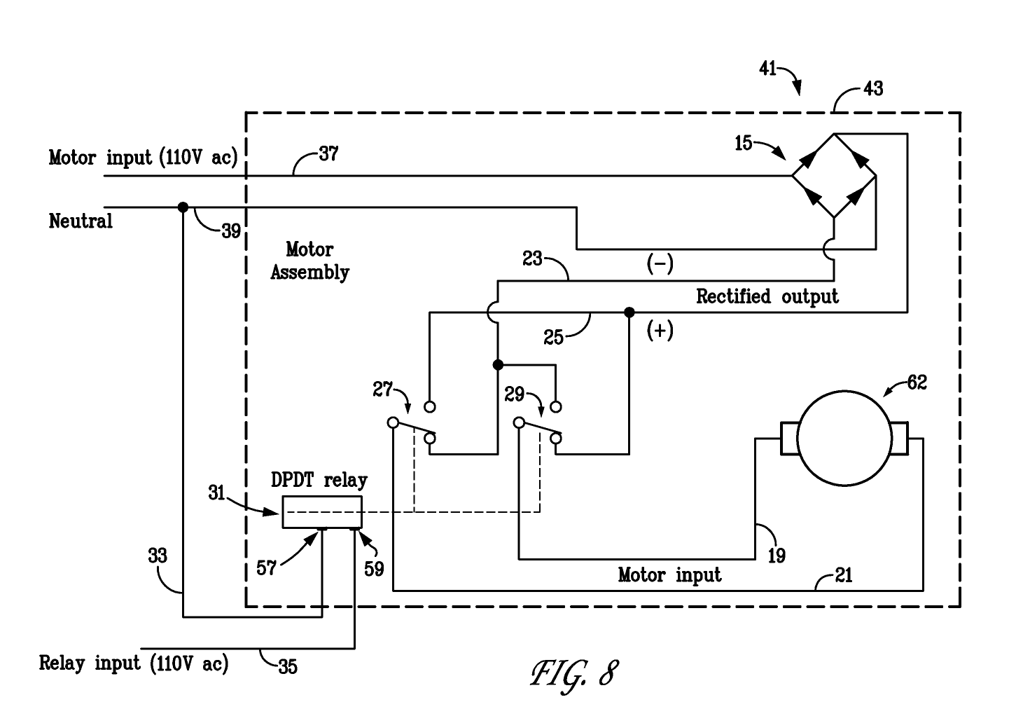

FIG. 8 illustrates a schematic diagram of a dispensing motor apparatus 41 that includes a motor 62 integrated with a reversing relay 31, in accordance with the disclosed embodiments. Note that the apparatus 41 can be implemented in association with the ice dispenser 52 and related components discussed earlier herein. The apparatus 41 generally includes a motor assembly 43 for driving a dispenser (e.g., dispenser 52). The motor assembly 43 includes a DC motor 62 and one or more relays such as, for example, relay 31. The relay 31 generally includes one or more electrical contacts 57 and 59. The relay 31 is integrated with motor 62. The dispenser 52 is driven by the motor 62, which changes its direction of rotation when its polarity is switched by the relay 31.

The controller 90 shown in FIG. 7 can communicate electrically with the relay 31, such that the controller 90 permits the relay 31 to switch the position of the contacts 57 and/or 59 before power is turned on with respect to the motor 62 through the electrical contacts 57 and 59 of the relay 31 and then switch the position of the electrical contacts 57 and 59 to a default state after the power is removed from the motor 62 through the electrical contacts 57 and 59 of the relay 31. In this manner, the relay 31 is subject to mechanical cycling without the contacts 57 and 59 of the relay being required to perform a current switching duty.

As shown in FIG. 8, the motor assembly 43 additionally includes a bridge rectifier circuit 15 that is electrically connected via electrical lines 23 and 25 to respective switches 27 and 29. Switches 27 and 29 are respectively electrically connected to motor input lines 21 and 19, which in turn electrically connect to motor 62. Note that a rectified signal can be output from the bridge circuit 15 along electrical lines 23 and 25. A motor input line 37 additionally can connect to the bridge circuit 15 and provide a motor input signal (e.g., 110 V AC) to the bridge rectifier circuit 15. A neutral connection can also be made to the bridge rectifier circuit 15 along electrical line 39. Similarly, a neutral connection can be provided to the relay 31 along line 33, which connects electrically to relate 31 and the electrical line 39. A relay input signal (e.g., 110 V AC) can be provided to the relay 31 along electrical line 35.

FIG. 9 illustrates a control logic chart 109, in accordance with the disclosed embodiments. The logic chart 109 generally includes an accounting of switching states “On” and “Off” with respect to a crushed mode and a cubed mode (i.e., different types of ice shapes). Thus, for example, a motor input can lead to “On” states with respect to both crushed and cubed nodes. A relay coil input leads to an “Off” state with respect to the crushed mode and an “On” state with respect to the cubed mode.

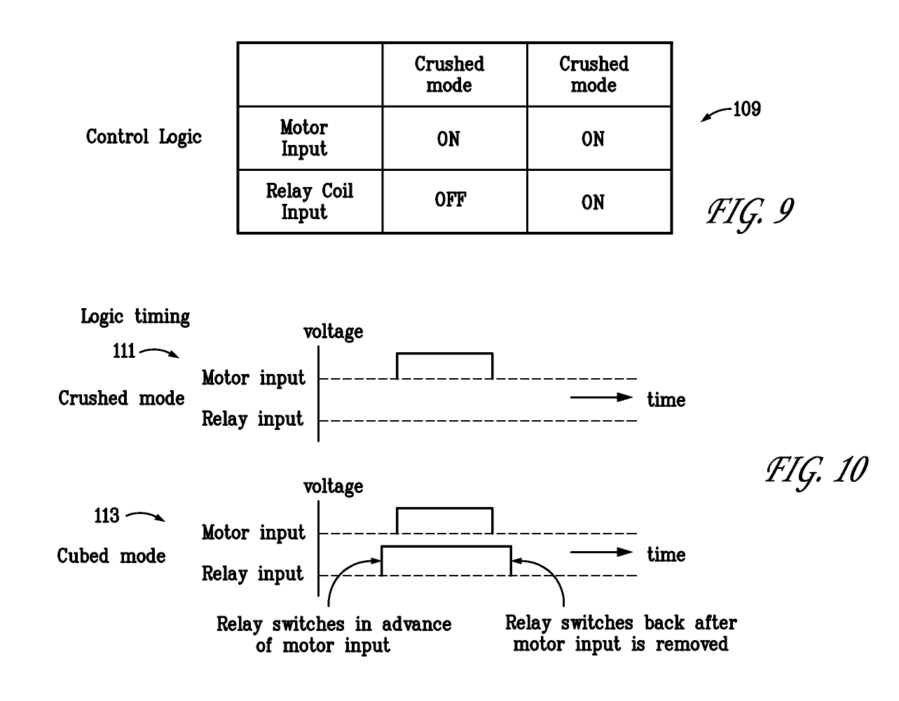

FIG. 10 illustrates logic timing diagrams 111 and 113 with respect to a crushed mode and a cubed mode, in accordance with the disclosed embodiments. The timing diagram 111 tracks the crushed mode and the motor input and the relay input with respect to voltage and time. The timing diagram 113 similarly tracks the cubed mode with respect to the motor input and relay input and voltage and time. Timing diagram 113 indicates, for example, that the relay 31 can switch in advance of the motor input and also switches back after the motor input is removed.

The logic diagram 109 shown in FIG. 9 and the timing diagrams 111 and 113 shown in FIG. 10 demonstrate that the control logic discussed herein causes the relay 31 to switch before the power is turned on to the motor 62 and switches back to a default state after the power is removed from the motor 62. In effect, the relay 31 is only subject to a mechanical cycling without its contacts 57 and 59 being stressed for current switching. Such a configuration enables the use of a very low power rating relay for, relay 31, which can then be very easily integrated into the motor assembly 43 of the apparatus 41. Such an arrangements saves a lot of space, makes factory assembly very simple and avoids errors at the factory during manufacture. The relay 31 is thus integrated into the motor assembly 43, which reduces considerably the cost of the apparatus 41 as well as improving manufacturability.

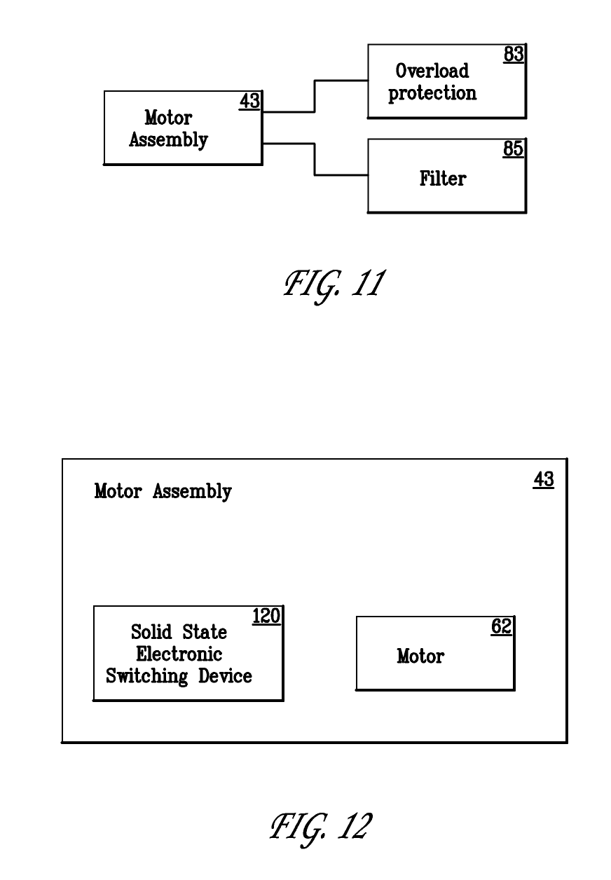

FIG. 11 illustrates a block diagram of the motor assembly 43 in association with an overload protection component 83 and a filter 85, in accordance with the disclosed embodiments. The filter 85 can be, for example, an EMI (Electromagnetic Interference) filter or an RFI (Radio Frequency Interference) filter depending upon design considerations.

FIG. 12 illustrates a block diagram of the motor assembly 43 in association with a solid-state electronic switching device 120, in accordance with an alternative embodiment. In the configuration depicted in FIG. 12, the motor assembly 43 is modified so instead of utilizing a mechanical relay (or relays) such as the previously described herein, the mechanical relay (containing a coil and electrical contacts) is replaced by the solid-state switching device 120. The motor assembly 43 of course includes the motor 62 and other necessary components, which will not be repeated here for brevity sake. The solid-state electronic switching device 120 can be, for example, a TRIAC (bidirectional triode thyristor) or a transistor or, for example, an opto-coupled device, depending upon design considerations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A dispensing motor apparatus comprising:
a motor assembly for driving a dispenser, the motor assembly comprising a motor;
at least one relay having electrical contacts, the at least one relay being integrated with the motor assembly, the dispenser being driven by the motor, which changes a direction of rotation when a polarity is switched by the at least one relay; and
a controller that communicates with the at least one relay and the motor assembly, the controller permitting the at least one relay to switch the position of the electrical contacts of the at least one relay before power is turned on with respect to the motor through the electrical contacts of the relay and switch the position of the electrical contacts of the at least one relay to a default state after the power is removed from the motor through the electrical contacts of the at least one relay, such that the at least one relay is subject to mechanical cycling without the electrical contacts of the at least one relay being required to perform a duty of current switching.

2. The dispensing motor apparatus of claim 1, wherein the dispenser comprises an ice bucket for dispensing ice.

3. The dispensing motor apparatus of claim 1, further comprising a filter that is electronically connected to the motor for filtering magnetic interference with respect to the motor assembly.

4. The dispensing motor apparatus of claim 1, further comprising an overload protection device electrically connected to the motor assembly for protecting the motor from a device overload.

5. The dispensing motor apparatus of claim 1, further comprising at least two electronic switches electronically connected to the at least relay and further in electrical connection with a bridge circuit and the motor.

6. The apparatus of claim 1, wherein the at least one relay comprises a solid-state relay component comprising an electronic switching device.
